(19) United States
(12) Patent Application Publication
(10) Pub. No.: US 2010/0151429 A1
(43) Pub. Date: Jun. 17, 2010

(54) Karaoke player, system and method thereof

(75) Inventor: Jim W. Chen, Taipei (TW)

Correspondence Address: BACON & THOMAS, PLLC, 625 SLATERS LANE, FOURTH FLOOR, ALEXANDRIA, VA, 22314-1176, US

(73) Assignee: Inventec Besta Co., Ltd., Taipei (TW)

(21) Appl. No.: 12/314,467

(22) Filed: Dec. 11, 2008

(51) Int. Cl. G10H 1/36; G10H 7/00

(52) U.S. Cl. 434/307 A; 84/645

(57) ABSTRACT

This specification provides a karaoke player, system and the method thereof. A goal of the player, the system and the method is to reduce the download data flux. Playing data that do not contain video signal are transmitted by a server to a signal processing device/karaoke player, which then decodes the playing data into audio signal and subtitle signal. A player/karaoke player plays the video signal, the audio signal, and the subtitle signal. Therefore, the player, the system and the method can enhance the data transmission efficiency.

### BACKGROUND OF THE INVENTION

1. Field of Invention

The invention relates to a karaoke player, system and the method thereof. In particular, the invention relates to a karaoke player and system that store a video signal at the non-server end and the method thereof.

2. Related Art

Singing has become one the common leisure activities of modern life. In addition to singing at KTV, more and more families have purchased karaoke systems to sing at home. The biggest drawback of the home karaoke systems is that the songs cannot be updated in real time or the user has to update them manually. This is quite inconvenient for most users.

Thanks to advances in network technology, digital TV (or set top box) has started providing services similar to those of karaoke systems. In such a system, songs are stored on a server. The digital TV (or set top box) downloads a play list for the user from the server via a network. After the user selects songs from the play list, the digital TV (or set top box) downloads the requested songs from the server.

The song played by a conventional karaoke system is usually an audio-video (AV) signal composed of video, audio, and subtitle signals. Therefore, the karaoke services provided by the digital TV (or set top box) are also done by downloading the AV signals of requested songs from the server and then playing them for the user. However, in order to play a song, video, audio, and subtitle signals have to be downloaded via the network. The AV-signal files are often very large in size. Therefore, downloading a song demands a lot of network flux, occupying a good portion of the bandwidth. This inevitably affects the overall data transmission efficiency.

### SUMMARY OF THE INVENTION

In view of the foregoing, the invention provides a karaoke player, system, and the method thereof to reduce the necessary download data.

The karaoke player disclosed herein includes a storage module, a request generating module, a transmission module, a signal decoding module, and a player module. The request generating module generates a request. The transmission module receives the playing data in response to the request. The signal decoding module decodes the playing data into an audio signal and a subtitle signal. Finally, the player module plays the audio, video, and subtitle signals stored in the storage module. Since the storage module has stored the video signal that occupies the most space, the invention can solve the problem of a large data flux when downloading songs via the network.

The disclosed karaoke playing system includes: a signal processing device, a server, and a player. The server includes: a first transmission module and a server module. The signal processing device includes: a storage module, a request generating module, a second transmission module, a signal decoding module, and a third transmission module. The player includes: a fourth transmission module, and a player module. The storage module of the signal processing device stores a video signal. The request generating module sends a request for playing data to the server module on the server. The signal decoding module on the signal processing device decodes the playing data into an audio signal and a subtitle signal. Afterwards, the playing module of the player plays the video, audio, and subtitle signals. The disclosed system thus solves the problem of large network flux for downloading songs.

The disclosed karaoke playing method includes the steps of: storing a video signal in the signal processing device; generating a request by the signal processing device; sending the request to the server from the signal processing device; transmitting playing data corresponding to the request from the server to the signal processing device; decoding the playing data into an audio signal and a subtitle signal at the signal processing device; transmitting the video, audio, and subtitle signals from the signal processing device to the player; and playing the video, audio, and subtitle signals using the player. The signal processing device stores the video signal. After it sends a request for the playing data to the server, the signal processing device decodes the playing data into the audio signal and the subtitle signal and plays the video, audio, and subtitle signals. The disclosed method thus solves the problem of large network flux for downloading songs.

In comparison with the requirement of a large network flux for downloading songs in the prior art, the invention can indeed reduce the download data to increase the data transmission efficiency.

### BRIEF DESCRIPTION OF THE DRAWINGS

The invention will become more fully understood from the detailed description given herein below illustration only, and thus is not limitative of the present invention, and wherein:

FIG. 1 shows the system structure of the disclosed karaoke playing system.

FIG. 2 is a flowchart of the disclosed karaoke playing method.

FIG. 3 is a schematic view of the disclosed karaoke player.

### DETAILED DESCRIPTION OF THE INVENTION

The present invention will be apparent from the following detailed description, which proceeds with reference to the accompanying drawings, wherein the same references relate to the same elements.

The audio signal and the subtitle signal referred herein have a temporal correspondence relation, such as the background music and subtitle in a song. However, they are not limited to such examples.

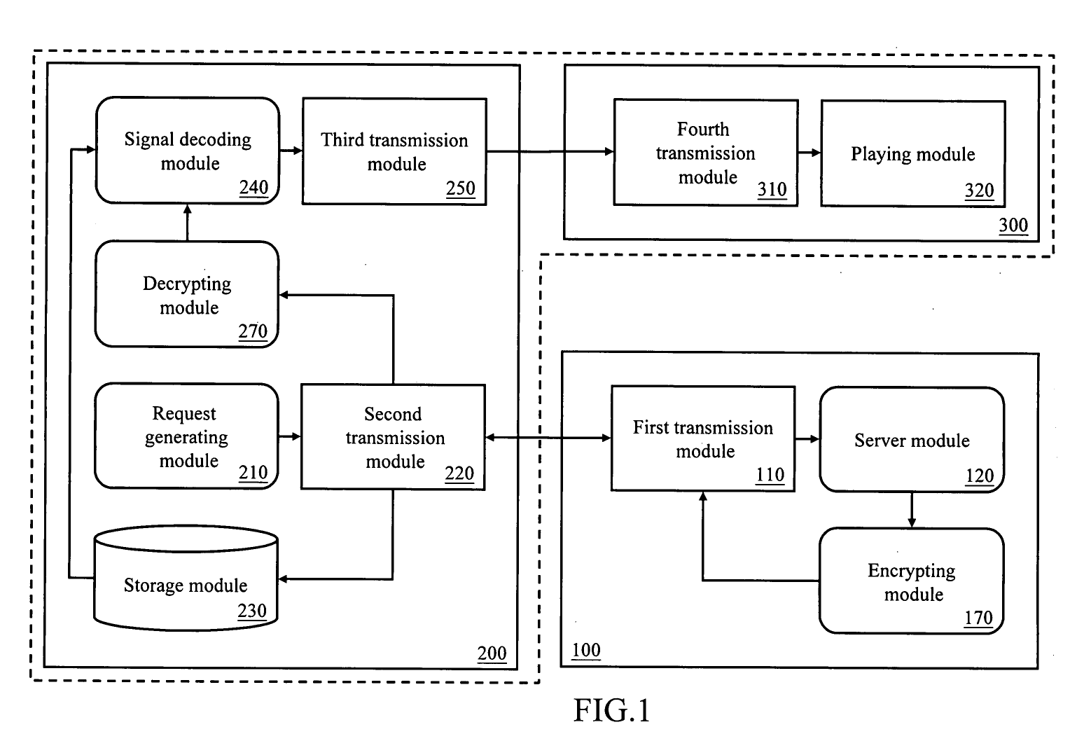

Please refer to FIG. 1 for the system structure of the disclosed karaoke playing system. As shown in the drawing, the disclosed system includes: a server 100, a signal processing device 200, and a player 300. The server 100 includes: a first transmission module 110 and a server module 120. The signal processing device 200 includes: a request generating module 210, a second transmission module 220, a storage module 230, a signal decoding module 240, and a third transmission module 250. The player 300 includes: a fourth transmission module 310 and a playing module 320.

The first transmission module 110 receives a request send from the second transmission module 220 of the signal processing device 200. It further transmits the playing data corresponding to the received request to the second transmission module 220 of the signal processing device 200.

The playing data are encoded so that an audio signal and a subtitle signal can be concurrently stored therein. For example, the audio signal and the subtitle signal can be stored in different channels in a way similar to the customized musical instrument digital interface (MIDI) format. However, the playing data referred herein are not limited to the MIDI format. Any other format that can concurrently store audio and subtitle can be employed by the invention. Moreover, if there are two or more subtitle signals, more different channels should be used.

After the first transmission module 110 receives the request sent from the second transmission module 220 of the signal processing device 200, the server module 120 reads the playing data corresponding to the request. It lets the first transmission module 110 to return the playing data to the second transmission module 220 of the signal processing signal 200.

The request generating module 210 generates a request for downloading the playing data.

The second transmission module 220 sends the request generated by the request generating module 210 to the first transmission module 110 of the server 100. It also receives the requested playing data returned by the first transmission module 110 of the server 100.

The storage module 230 stores a video signal. The stored the video signal is stored in advance in the storage module 230 of the signal processing device 200.

The signal decoding module 240 decodes the playing data received by the second transmission module 220 into an audio signal and at least one subtitle signal.

The third transmission module 250 transmits the video signals stored in the storage module 230 and the audio signal and the subtitle signal generated by the signal decoding module 240 to the fourth transmission module 310 of the player 300.

The fourth transmission module 310 receives the video, audio, and subtitle signals transmitted from the third transmission module 250 of the signal processing device 200.

The playing module 320 simultaneously plays the video and audio signals received by the fourth transmission module 310. At the same time, each section of subtitle in each subtitle signal is played according to the corresponding time tag by the playing module 320.

In the hardware implementation, the signal processing device 200 and the player 300 can be parts of a digital TV, in addition to connecting the third transmission module 250 and the fourth transmission module 310 using a transmission line. In the digital TV, the third transmission module 250 and the fourth transmission module 310 are connected directly by a circuit.

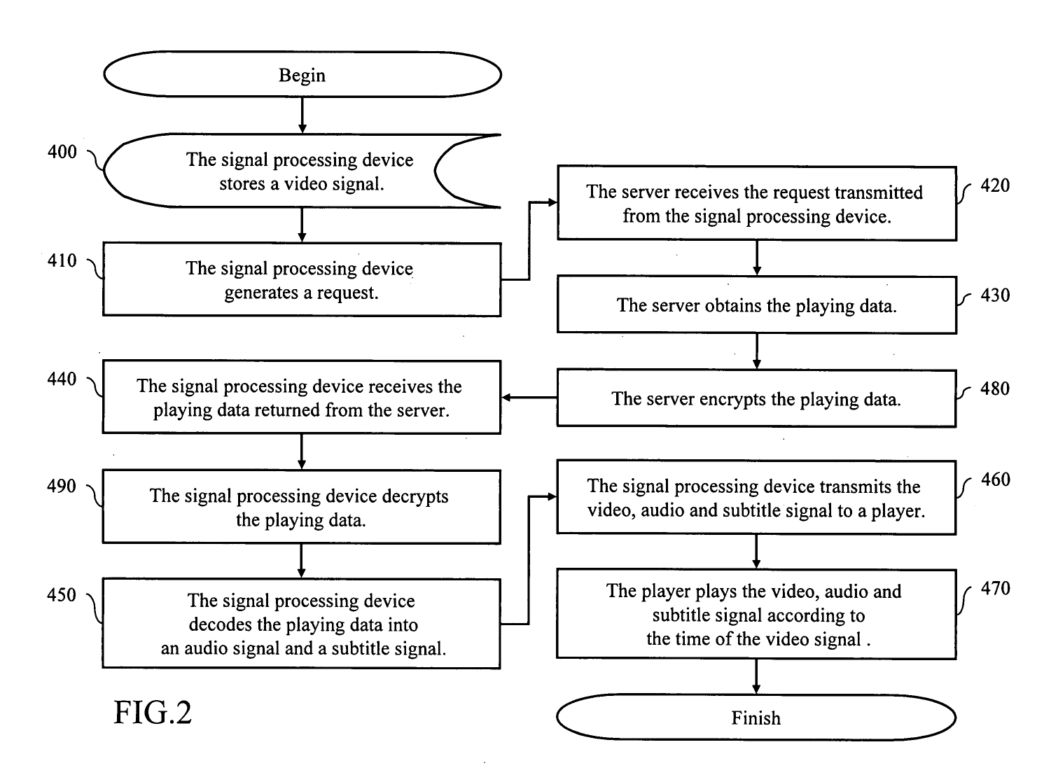

In the following, an explicit embodiment is used to explain the operations of the disclosed system and method. Please refer to FIG. 2 for a flowchart of the disclosed karaoke playing method.

In this embodiment, the server 100 is a web server. The invention, however, is not limited by this example. Any other server that can transmit playing data to the signal processing device 200 can be used in the invention. The signal processing device 200 is a set top box. Again, the invention is not limited to this example. Any device that combines received the video, audio, and subtitle signal into AV signal playable by the player 300 can be used. The player 300 in this embodiment is a TV. The invention is not limited to this example, either. Any player that can play the AV signal transmitted from the signal processing device 200 can be used by the invention. The playing data in this embodiment include the audio and subtitle signal of a song for singing. In general, the playing data of the invention are not limited to songs. Moreover, the playing data in this embodiment utilizes the customized MIDI format to store the audio and subtitle signal. However, the playing data of the invention are not restricted to the customized MIDI format.

The storage module 230 in the set top box (signal processing device 200) has already been stored with a video signal of songs from the vendor (step 400). Besides, the storage module 230 also stores other information related to the songs as well.

When a user wants to play a song in order to sing along, the request generating module 210 in the set top box generates a request (step 410). Afterwards, the second transmission module 220 in the set top box sends the request generated by the request generating module 210 to the web server of the embodiment (server 100).

After the first transmission module 110 on the web server receives the request (step 420), the server module 120 thereon obtains and receives playing data corresponding to the request (step 430). The method for the server module 120 to obtain the playing data can be reading in the storage module (not shown) of the server 100 (web server) or downloading from the storage device (not shown) connected with the server 100. However, the invention is not restricted by these two examples.

After the server module 120 obtains the audio and subtitle signal of the song, it returns the playing data in the MIDI format to the second transmission module 220 of the set top box via the first transmission module 110.

After the second transmission module 220 receives the playing data transmitted from the first transmission module 110 of the web server (step 440), the signal decoding module 240 on the set top box extracts an audio signal and at least one subtitle signal stored in different channels of the playing data. That is, the playing data are decoded into audio signal and at least one subtitle signal (step 450). If there is only one subtitle signal, the audio signal and the subtitle signal use distinct channels. If there are two subtitle signals, then the audio signal uses one channel and the two subtitle signals use two distinct channels.

After the signal decoding module 240 on the set top box extracts audio signal and at least one subtitle signal stored in different channels of the playing data (step 450), the third transmission module 250 of the set top box transmits the audio and subtitle signals decoded by the signal decoding module 240 and the video signal stored in the storage module 230 to the fourth transmission module 310 of the TV (player 300) (step 460).

After the fourth transmission module 310 of the TV receives the audio, subtitle, and video signals transmitted from the third transmission module 250 of the set top box, the playing module 320 of the TV plays these signals (step 470). As described, the invention does not need to download the video signal of the request song. The download data size is reduced. Therefore, it solves the problem of large network flux for download data in the prior art.

Moreover, the disclosed web server (server 100) can further includes an encrypting module 170 and the set top box (signal processing device 200) includes a decrypting module 270, so that the web server uses the encrypting module 180 to encrypt the playing data before sending them to the set top box using the first transmission module 110 (step 480). After the set top box receives the playing data returned from the web server (step 440), it first decrypts the playing data (step 490) and then decodes the playing data into audio and subtitle signal (step 450). This mechanism can prevent the playing data from being eavesdropped during the transmission.

Besides, the web server (server 100) can transmit video signal to the set top box (signal processing device 200) via the first transmission module 110 by streaming. The second transmission module transmits the received video signal to the storage module 230 to store. This can increase the video signal stored in the storage module 230.

The above-mentioned embodiment uses the set top box (signal processing device 200) to download the playing data and decode them into audio signal and subtitle signal. Afterwards, the TV (player 300) plays the video, audio, and subtitle signals. In practice, the signal processing device 200 and the player 300 can be combined into a karaoke player 500, such as a digital TV that can process and play signal.

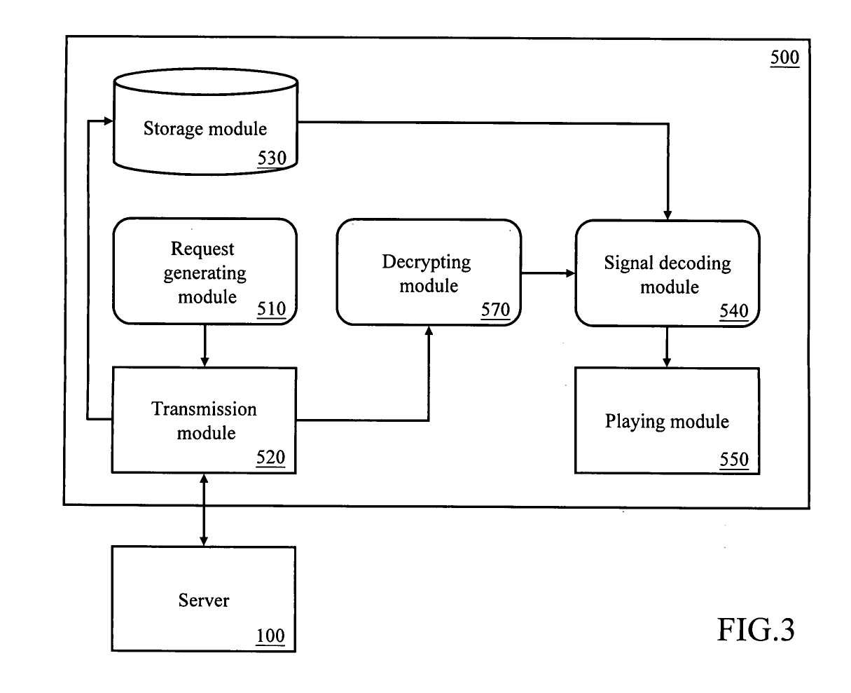

As shown in FIG. 3, the disclosed karaoke player 500 includes a request generating module 510, a transmission module 520, a storage module 530, a signal decoding module 540, and a playing module 550.

The request generating module 510, the transmission module 520, the storage module 530, and the signal decoding module 540 are the same as the request generating module 210, the second transmission module 220, the storage module 230, and the signal decoding module 240 in the karaoke playing system of FIG. 1. The playing module 550 plays the audio and subtitle signal decoded by the signal decoding module 540 and the video signal stored in the storage module 530.

The karaoke player 500 can further include a decrypting module 570. If the playing data received by the transmission module 520 are encrypted, the decrypting module 570 can decrypt the encrypted playing data so that the signal decoding module 540 can combine the decrypted playing data with the video signal into AV signal.

Besides, when the transmission module 520 of the karaoke player 500 receives the video signal transmitted from the server 100 by streaming, the storage module 230 is enabled to store the video signal received by the transmission module 520.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A karaoke playing system, comprising:
a server, including:
a first transmission module for receiving a request; and
a server module for transmitting a playing data corresponding to the request after the first transmission module receives the request, the playing data including an audio signal and at least one subtitle signal;
a signal processing device, including:
a storage module for storing at least one video signal;
a request generating module for generating the request;
a second transmission module for sending the request to the server and receiving the playing data from the server;
a signal decoding module for decoding the playing data into the audio signal and the subtitle signal; and
a third transmission module for transmitting the video signal, the audio signal, and the subtitle signal; and
a player, including:
a fourth transmission module for receiving the video signal, the audio signal, and the subtitle signal transmitted from the signal processing device; and
a playing module for playing the video signal, the audio signal, and the subtitle signal according to the time of the video signal.

2. The karaoke playing system of claim 1, wherein the signal processing device is a set box (STB).

3. The karaoke playing system of claim 1, wherein the playing data are in the customized musical instrument digital interface (MIDI) format.

4. The karaoke playing system of claim 3, wherein the playing data use different channels to store the audio signal and the subtitle signal.

5. The karaoke playing system of claim 1 further comprising:
an encrypting module disposed on the server for encrypting the playing data; and
a decrypting module disposed on the signal processing device for decrypting the playing data.

6. The karaoke playing system of claim 1, wherein the second transmission module further receives the video signal transmitted from the first transmission module via streaming and the storage module further stores the video signal.

7. A karaoke playing method, comprising the steps of:
storing at least one video signal in a signal processing device;
generating a request from the signal processing device;
sending the request from the signal processing device to a server;
transmitting a playing data corresponding to the request from the server to the signal processing device, the playing data including an audio signal and at least one subtitle signal;
decoding the playing data by the signal processing device into the audio signal and the subtitle signal;
transmitting the video signal, the audio signal, and the subtitle signal from the signal processing device to a player; and
playing the video signal, the audio signal, and the subtitle signal according to the time of the video signal using the player.

8. The karaoke playing method of claim 7, wherein the step of transmitting the playing data from the server further includes the step of storing the audio signal and the subtitle signal in different channels of the playing data by the server.

9. The karaoke playing method of claim 7 further comprising the steps of:
encrypting the playing data by the server; and
decrypting the playing data using the signal processing device.

10. The karaoke playing method of claim 7 further comprising the steps of:
transmitting the video signal from the server by streaming; and
receiving and storing the video signal using the signal processing device.

11. A karaoke player, comprising:
a storage module for storing a video signal;
a request generating module for generating a request;
a transmission module for sending the request and receiving a playing data corresponding to the request, the playing data including an audio signal and at least one subtitle signal;
a signal decoding module for decoding the playing data into audio signal and the subtitle signal; and
a playing module for playing the video signal, the audio signal, and the subtitle signal according to the time of the video signal.

12. The karaoke player of claim 11 being a digital television (TV).

13. The karaoke player of claim 11, wherein the playing data is in the customized MIDI format.

14. The karaoke player of claim 13, wherein the playing data use different channels to store the audio signal and the subtitle signal.

15. The karaoke player of claim 11 further comprising a decrypting module for decrypting the playing data received by the transmission module when they are encrypted.

16. The karaoke player of claim 11, wherein the transmission module further receives the video signal transmitted form the server by streaming and the storage module further stores the video signal.
